(19) United States
(12) Patent Application Publication
(10) Pub. No.: US 2007/0212441 A1
(43) Pub. Date: Sep. 13, 2007

(54) Molded part picker

(75) Inventors: Omeir Shahid Ansari, Markham (CA); Michael K. Zuraw, Georgetown (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/372,017

(22) Filed: Mar. 10, 2006

(51) Int. Cl. B29C 49/00

(52) U.S. Cl. 425/533; 425/534

(57) ABSTRACT

Disclosed is a molded part picker for a molded part handling system. The molded part picker includes a balloon having a wear member for contacting a molded part when the balloon is positioned and inflated to do so, and the wear member disengages from the molded part when the balloon is deflated to do so.

### TECHNICAL FIELD

The present invention generally relates to molded part pickers, and more specifically the present invention relates to, but is not limited to, a molded part transfer device including the molded part picker.

### BACKGROUND

Some injection molded parts, for example plastic preforms of the variety that are for blow molding into beverage bottles, require extended cooling periods to solidify into substantially defect-free molded parts. To the extent that the cooling of the molded part can be effected outside of the injection mold by one or more post-mold transfer and cooling devices then the productivity of the injection mold may be increased (i.e. lower cycle time). A variety of such post-mold molded part transfer and cooling devices, and related methods, are known and have proven effective at the optimization of the injection molding machine cycle time.

In a typical injection molding system a molded partially cooled molded part is ejected from the injection mold and into a cooled carrier of a take-out plate, for post-mold cooling thereof, once an initially cooled surface skin has formed on the molded part that allows for its ejection without a deformation thereof.

U.S. Pat. No. Re. 33,237 discloses a post-mold transfer and cooling device that includes a robotically-controlled multi-position take-out plate for removing molded partially cooled injection molded parts from the core side of an injection mold. The molded parts are ejected from the mold directly into cooled carriers, as disclosed in commonly assigned U.S. Pat. No. 4,729,732, and transported by the robot to an outboard position. The plate has multiple sets of carriers, each set being sufficient in number to hold one molded part from each of the cores of the multi-cavity mold. There are multiple sets of carriers on the plate so that multiple sets of molded parts can be held and cooled, the set that is ejected from the carriers being the set that has been cooling the longest. Without a positive ejection force, molded parts can stick in the carriers and cause an interruption in the molding cycle.

Commonly assigned U.S. Pat. No. 6,171,541 discloses a post-mold cooling transfer and cooling device that includes a cooling pin for insertion into the interior of a molded partially cooled molded part, while the molded part is arranged in the cooled carrier of the take-out plate, to discharge a cooling fluid therein. The foregoing is sold under the trade name of COOLJET, a trade-mark of Husky Injection Molding Systems Limited. Also disclosed is a procedure to apply a vacuum through the same cooling pin to cause the molded part to remain with the pin when it is moved away from the carrier holding the molded part, thereby removing the molded part from the carrier. The pins, mounted to a frame, may be rotated 90 degrees to a discharge position and the vacuum terminated to allow the molded parts to fall off the pins.

Co-pending, commonly assigned, United States published application 2004/0185136 published Sep. 23, 2004 describes an injection molding system that includes both of the foregoing take-out and COOLJET devices that cooperate to handle and cool the molded parts once ejected from the injection mold.

The foregoing injection molding system has been sold under the trade name of HYPET, a trade-mark of Husky Injection Molding Systems Limited, for the manufacture of beverage preforms and the like. The HYPET system is known to incorporate an expandable picker 50, as shown with reference to FIGS. 2A and 2B, for use on the COOLJET device, for a positive removal of a molded part from a carrier by gripping the molded parts along an inside surface thereof that supplements or replaces a vacuum assisted transfer by the cooling pin. The foregoing combination of COOLJET and molded part picker is sold under the trade name of COOLPIK, a trade-mark of Husky Injection Molding Systems Limited. A typical molded part picker 50 includes a balloon 53, preferably formed form a length of tubing 52 of a stretchable and resilient material, which is crimped by rings 54 to a frame 56 about its ends to define an fluid chamber 58 between the tubing 52 and the frame 56. The frame 56 may include barbs 57 configured on the outside thereof, in the vicinity to where the tubing 52 is to be crimped, to prevent unwanted shifting of the tubing along the frame 56. The frame 56 also preferably includes several pressure channels 60 through which a fluid may enter or exit for causing an expansion or contraction, respectively, of the fluid chamber 58. The tubing 52 is preferably arranged on the frame 56 to include a folded-over portion 62 at one end. The folded-over portion 62 has the technical effect of reducing the expansion pressure required for a given radial deflection of the tubing 52, relative to tubing that is mounted to the sleeve without the folded-over portion. Alternatively, molded part pickers are available that lack a folded-over portion, or that are made from a molded balloon. The balloons 53 used in the known molded part pickers have included smooth walls.

U.S. Pat. No. 4,783,108, assigned to Bridgestone Corporation, describes the construction of an expandable picker that is similar to the ‘folded-over’ picker used on the HYPET system.

Examples of commercially available expandable pickers are the AIRPICKER, a trade-mark of Firestone Corporation, that is available from Firestone Industrial Products (www.firestoneindustrial.com), and the expandable pickers available from Anver Corporation (www.anver.com). Expandable pickers are sold for many uses that also include preform handling in a blow molding and bottling environments.

With reference to FIG. 1, a plan view of the HYPET injection molding system 10 is shown to include an injection unit 11, a clamp unit 12, a take-out device 13, and a COOLPIK device 14. Also included is an injection mold comprising the cavity half 35, containing mold cavities (not shown), attached to the stationary platen 16 of the machine 10, and the core half 17 which is attached to the moving platen 41 of the machine 10.

The take-out device 13 is mounted on the stationary platen 16 and includes a horizontal “Z” beam 20 that projects to the non-operator side of the machine and upon which rides a carriage 21, moved along the beam by (typically) a servo-electric driven belt drive (not shown). Multi-position plate 23 is attached to the carriage 21. Multiple sets of carriers 24 are mounted on plate 23 and may be cooled for transporting multiple molded shots of molded parts ejected from the mold from an inboard (loading) position (not shown).

The COOLPIK device 14 includes a cooling plate 25 upon which are mounted multiple cooling pins 26. A hollow structure 45 attaches a plenum 29, on which the plate 25 is mounted, to the hollow cylinder 40, and allows services to be carried from the machine through the structure 45 to the plenum 29 and plate 25. The plate 25 and plenum 29 can be rotated very quickly through a 90-degree arc by any suitable means. For example, the rotation of the plate 25 can be effected by an electric drive (not shown) mounted to the hollow structure 45. The plate 25 and plenum 29 preferably move toward and away from the carriers 24 with the movement of the moving platen 41.

In operation, one shot of molded parts is transferred into the carriers 24 when the mold is open and the multi-position take-out plate 23 is positioned such that empty carriers are aligned with molded parts on the mold cores. In the example shown in FIG. 1, a 32-cavity mold is transferring 32 molded parts into 32 carriers on a 3 position take-out plate 23. The multi-position take-out plate 23 is then moved to its outboard position by the robot 13, as shown in FIG. 1. The mold is then closed and clamped for the next molding cycle. Meanwhile, as the mold closes, the COOLPIK device 14 moves the plate 25 and the pickers 50 so as to grasp one third or 32 of the molded parts 2 held in the carriers 24, as shown with reference to FIG. 3. At the same time, a cooling pin 26 enters each of the 96 molded parts 2 held by the carriers 24 for circulating a cooling fluid that enters the cooling pins 26 from the plenum 29.

When the molding cycle ends and the mold opens, the pickers extract one third or, in this case, 32 of the molded parts 109 from the carriers 24 on the plate 23, as shown with reference to FIG. 4. The plate 25 is then retracted and rotated 90 degrees and the molded parts held by the pickers 50 are dropped onto a conveyor beneath (not shown). The remaining molded parts continue to be held in their carriers 24 by vacuum.

The plate 25, preferably made of lightweight aluminum, or similar material, carries cooling pins 26 sufficient in number to exceed the number of carriers 24 on the multi-position carrier plate 23 by a number equivalent to two rows of carriers 24. Rows of picker devices 50 are provided with every third row of cooling pins 26′. As shown with reference to FIGS. 3 and 4, the frame 56 of the picker 50, shown in FIG. 2B, may be alternatively replaced by the cooling pin 26′ that is mounted on a stub 30 arranged in the plate 25. An air channel is provided along a slender gap (not readily shown) between an inside surface of the cooling pin 26′ and an outside surface of the stub 30 for connecting the pressure channels 60 with an air pressure source 31 in the plate 25. The remaining cooling pins 26 are also preferably connected to the plate 25 using a stub 30′.

A significant problem with foregoing picker 50 involves a premature wear-related thinning of the tubing 52 along the outside comer 64 of the tubing 52 where it folds over on itself (the interrupted line represents the worn outer surface of the tubing at the outer comer 64). The thinning tubing 52 eventually ruptures when expanded. The wear along the outside comer 64 is thought to be the result of the repeated rubbing between the tubing 52 and the inside surface of the molded part 2. The rubbing is exacerbated whenever there is misalignment between the picker 50 and the molded part 2. The service life of a typical picker 50 is between a half and one million cycles. The failure of even one picker 50 in the array will require its immediate replacement and will result in a significant interruption in the productivity of the injection molding system.

### SUMMARY

By improving the wear characteristics of the picker, its service life can be extended. By increasing the service life of the picker, a reduction in the maintenance requirements in a molded part handling system can be achieved, particularly unplanned maintenance, and thereby improve the availability and hence productivity of the overall system which may increase manufacturing profitability. The present invention mitigates the problems associated with known pickers at least in molded part.

According to a first aspect of the present invention, there is provided a molded part picker for a molded part handling system. The molded part picker includes a balloon having a wear member for contacting a molded part when the balloon is positioned and inflated to do so, and the wear member disengages from the molded part when the balloon is deflated to do so.

According to a second aspect of the present invention, there is provided a molded part transfer device that includes the molded part picker in accordance with the first aspect of the present invention.

According to a third aspect of the present invention, there is provided an injection molding system having a molded part transfer device that includes the molded part picker in accordance with the first aspect of the present invention.

A technical effect of the aspects of the present invention is to immolded part an increased wear resistance in a molded part picker, whereby its service life can be extended. By improving the service life of the picker a reduction in the maintenance requirements in a molded part handling system can be achieved, particularly unplanned maintenance, and thereby improve the availability and hence productivity of the overall system which may increase manufacturing profitability.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIG. 1 is a plan view of a known injection molding system having a take out device and a COOLPIK device, the COOLPIK device including known molded part pickers;

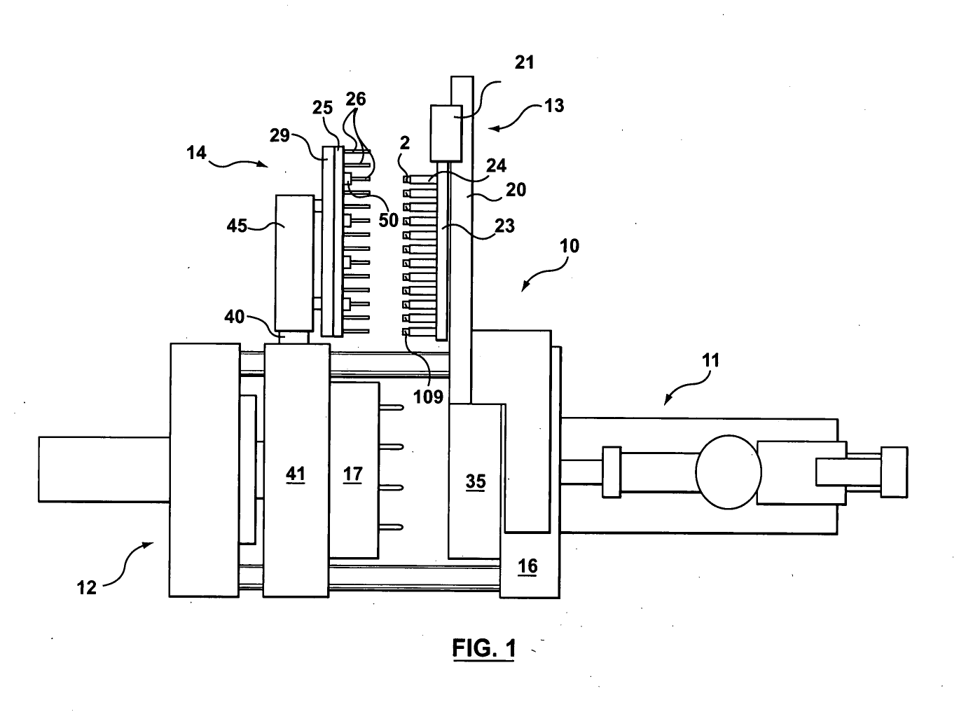

FIG. 2A is an isometric view of the known molded part picker of FIG. 1;

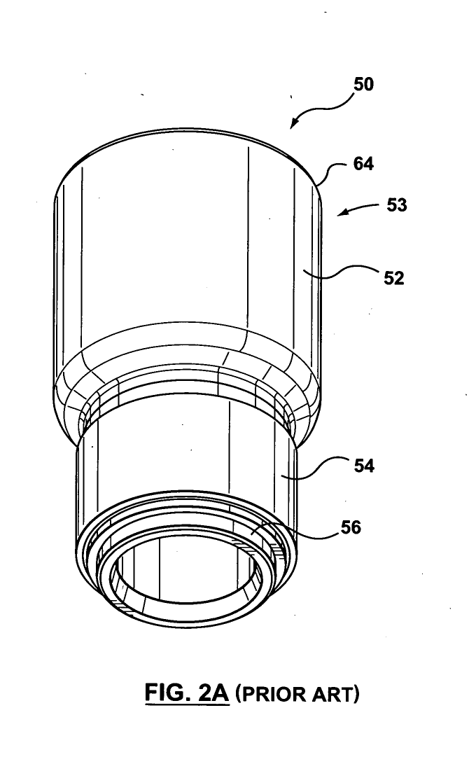

FIG. 2B is a section view of the known molded part picker of FIG. 1;

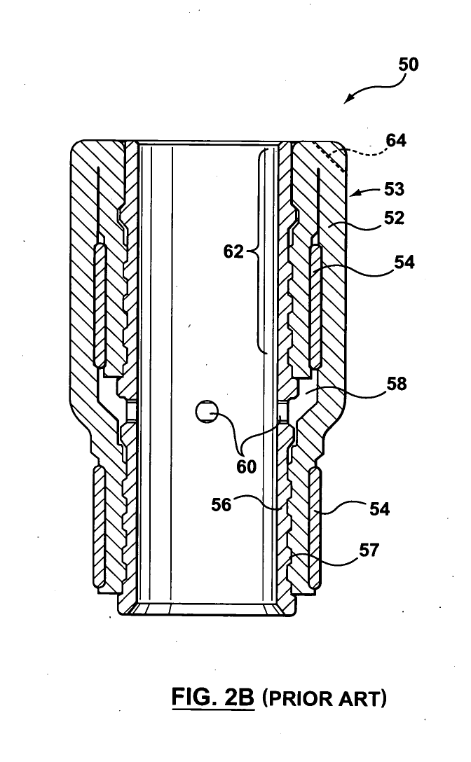

FIG. 3 is a section view of the known take-out and COOLPIK devices of FIG. 1 during a cooling of molded parts;

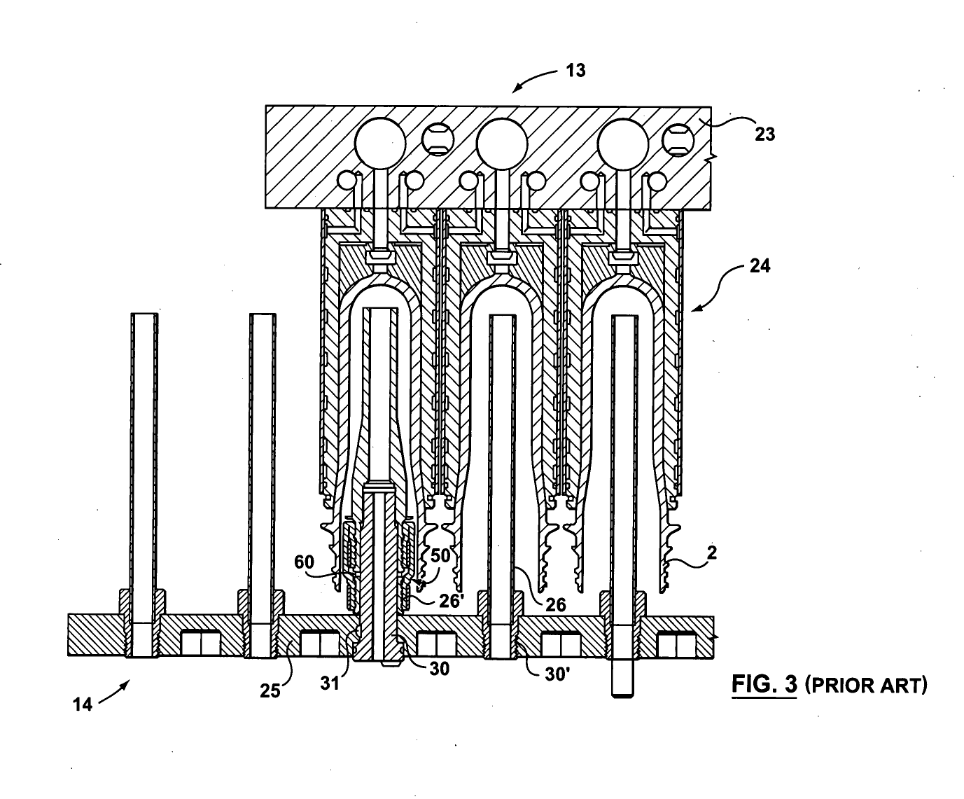

FIG. 4 is a section view of the known COOLPIK device of FIG. 1 with a molded part being held by the known molded part picker;

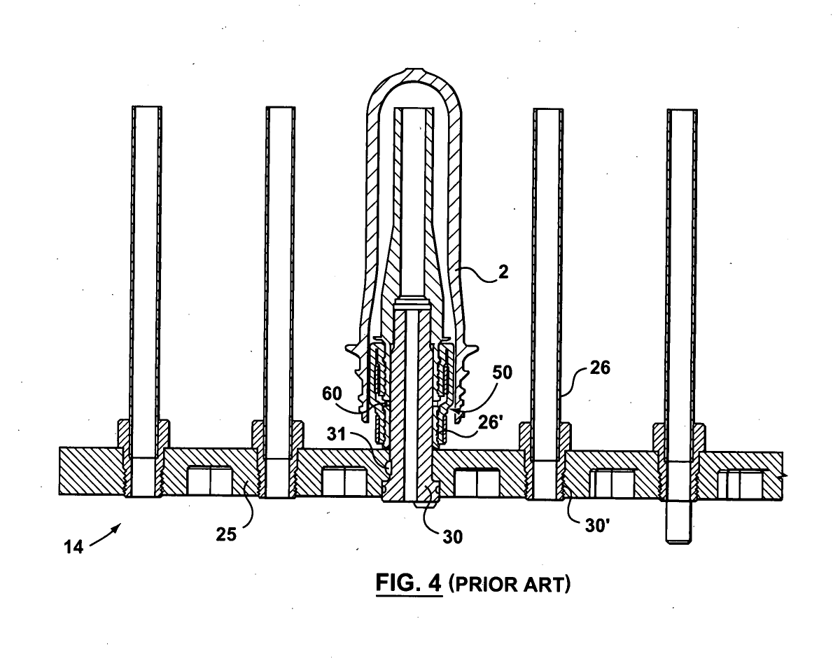

FIG. 5A is an isometric view of a molded part picker in accordance with a first embodiment of the present invention;

FIG. 5B is an top view of the tubing, as extruded, for fabricating the molded part picker of FIG. 5A;

FIG. 6 is an isometric view of a molded part picker in accordance with a second embodiment of the present invention;

FIG. 7 is an isometric view of a molded part picker in accordance with a third embodiment of the present invention;

FIG. 8 is an isometric view of a molded part picker in accordance with a fourth embodiment of the present invention;

FIG. 9 is an isometric view of a molded part picker in accordance with a fifth embodiment of the present invention;

FIG. 10 is an isometric view of a molded part picker in accordance with a sixth embodiment of the present invention; and

FIG. 11 is an isometric view of a molded part picker in accordance with a seventh embodiment of the present invention.

### DETAILED DESCRIPTION

The exemplary embodiments of a molded part picker are described below along with a description of the increased wear resistance associated with using some of the exemplary embodiments.

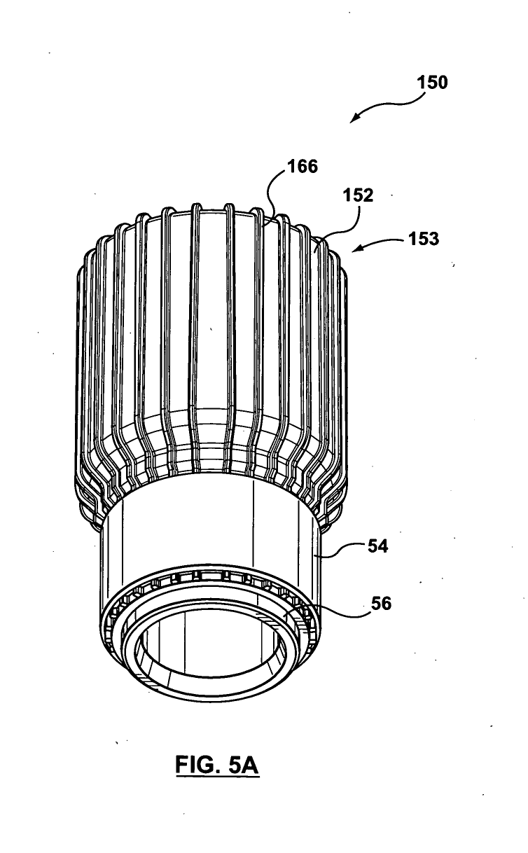

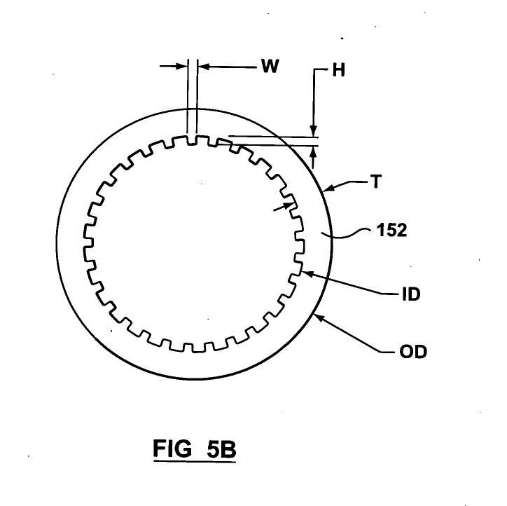

FIGS. 5 through 11 illustrate isometric views of exemplary molded part pickers 150, 250, 350, 450, 550, 650, and 750 in accordance with some of the many possible embodiments of the present invention. The molded part pickers 150, 250, 350, 450, 550, 650, and 750 are preferably configured to be similar to the known molded part picker 50 described hereinbefore, the balloon 153, 253, 353, 453, 553, 653, 753 further including one or more wear members 166, 266, 366, 466, 566, 666, 766 for contacting a molded part 2 when the balloon 153, 253, 353, 453, 553, 653, 753 is positioned and inflated to do so, and the wear member 166, 266, 366, 466, 566, 666, 766 disengages from the molded part 2 when the balloon 153, 253, 353, 453, 553, 653, 753 is deflated to do so. Of course, those skilled in the art of molded part handling would recognize that the wear members 166, 266, 366, 466, 566, 666, and 766 of the present invention may also provide similar utility on other known configurations of expandable molded part pickers, including the previously described alternative embodiment wherein the frame 56 of the picker 50 is provided by the cooling pin 26′ of the COOLPIK device.

In view of the foregoing, the description hereinafter will focus only on the implementation of the wear members 166, 266, 366, 466, 566, 666, and 766.

FIG. 5A illustrates the molded part picker 150 in accordance with the first embodiment (which is the preferred embodiment) of the present invention. The balloon 153 preferably comprises tubing 152 having a plurality of wear members 166 disposed in a pattern thereon. The plurality of wear members are preferably arranged to extend longitudinally, that is in the same direction as a longitudinal axis of the frame 56, along the length of the tubing 152. A possible advantage to the use of longitudinally oriented wear members 166 is that they are thought to be less likely to impede the radial expansion of the tubing. The pattern also preferably includes arranging the longitudinally extending wear members 166 in a equi-angularly-spaced array around the tubing 152. The angular spacing between adjacent wear members 166 is preferably chosen as a function of the radial height of the wear member 166, whereby in the expanded condition the web of tubing 152 between adjacent wear members 166 preferably does not come into wear inducing contact with the molded part. The foregoing may be accomplished by configuring the tubing 152 and wear members 166 in accordance with the exemplary specifications listed in TABLE 1 and as shown with reference to FIG. 5B, wherein the tubing includes wear members having a generally rectangular cross-sectional shape, and wherein the dimension W is the width of the wear member 166, dimension H is the height of the wear member 166, dimension T is the thickness of the tubing 152, dimension ID is the inside diameter of the tubing, as extruded, and dimension OD is the outside dimension of the tubing 152 as extruded. All dimensions listed in TABLE 1 are in millimeters. The tubing 152 in FIG. 5B depicts the wear members 166 on the inside diameter due to the way in which the molded part picker is assembled (i.e. the tubing 152 is first folded-over on the frame 56). Preferably a sealant, such as silicone, is applied between the frame 56 and the tubing 152.

TABLE 1

| | | | | | Number |
|---|---|---|---|---|---|
| | | | | | of Wear |
| W (mm) | H (mm) | T (mm) | ID (mm) | OD (mm) | Members |
| 0.5 | 0.5 | 1.6 | 7.94 | 11.11 | 19 |
| 0.5 | 0.5 | 1.6 | 10.32 | 13.49 | 24 |
| 0.5 | 0.5 | 1.6 | 12.70 | 15.88 | 29 |
| 0.5 | 0.5 | 1.6 | 14.29 | 17.46 | 33 |
| 0.5 | 0.5 | 1.6 | 15.88 | 19.05 | 37 |
| 0.5 | 0.5 | 1.6 | 17.46 | 20.64 | 40 |
| 0.5 | 0.5 | 1.6 | 19.05 | 22.23 | 44 |
| 0.5 | 0.5 | 1.6 | 20.64 | 23.81 | 47 |
| 0.5 | 0.5 | 1.6 | 23.81 | 26.99 | 55 |
| 0.5 | 0.5 | 1.6 | 25.40 | 28.58 | 58 |
| 0.5 | 0.5 | 1.6 | 26.99 | 30.16 | 62 |
| 0.5 | 0.5 | 1.6 | 28.57 | 31.75 | 66 |
| 0.5 | 0.5 | 1.6 | 41.27 | 44.45 | 94 |

Of course, other shapes and dimensions of wear members are possible. For example, alternative tubing has a width W and height H dimensions that are each preferably about 0.7 millimeters. In addition, the shape of the wear member shape may otherwise be semi-circular, triangular, or just about any other polygon.

Notwithstanding the foregoing, the tubing 152 is preferably configured to have a nominal wall thickness between about 1 and 2 millimeters, and wherein the wear member has a nominal height of between about 0.4 and 1 millimeter and a width between about 0.4 and 1 millimeter.

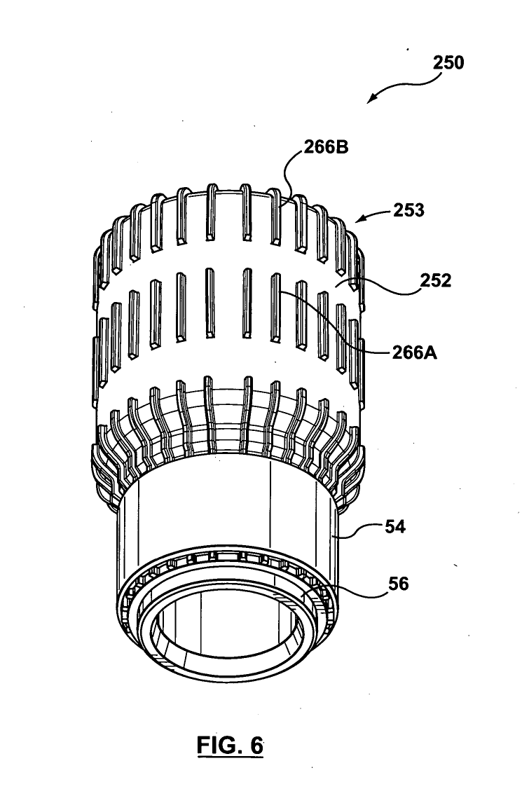

FIG. 6 illustrates the molded part picker 250 in accordance with a second embodiment of the present invention. The molded part picker 250 includes a balloon 253 that is configured similarly to the first embodiment except that the tubing 252 includes segmented longitudinal wear members 266 (i.e. there is a gap between adjacent wear members, for example, 266A and 266B).

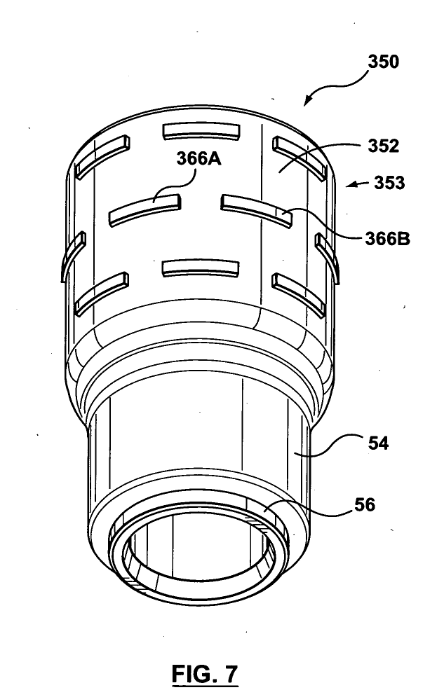

FIG. 7 illustrates the molded part picker 350 in accordance with a third embodiment of the present invention. The molded part picker 350 includes a balloon 353 that is configured similarly to the first embodiment except that the tubing 352 includes a plurality of wear members 366 that have been arranged to extend circumferentially, that is in a direction that is substantially perpendicular to the longitudinal axis of the frame 56, around the outside of the tubing 352. The circumferentially extending wear members 366 are also arranged in a longitudinally-spaced array along the length of the tubing 352. The circumferentially extending wear members 366 of tubing 352 are preferably segmented into discrete curved wear members 366 on tubing 352 (i.e. there is a gap between adjacent wear members, for example, 366A and 366B) such that the radial expansion of the tubing 352 is not significantly impeded.

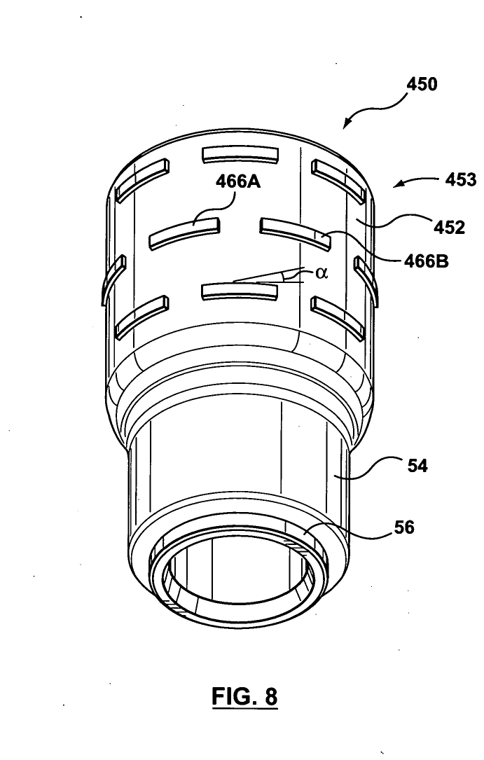

FIG. 8 illustrates the molded part picker 450 in accordance with a fourth embodiment of the present invention. The molded part picker 450 includes a balloon 453 that is configured similarly to the balloon 353 of the third embodiment except that the circumferentially extending wear members 466 of tubing 452 have been arranged on a helix angle α relative to the longitudinal axis of the frame 56.

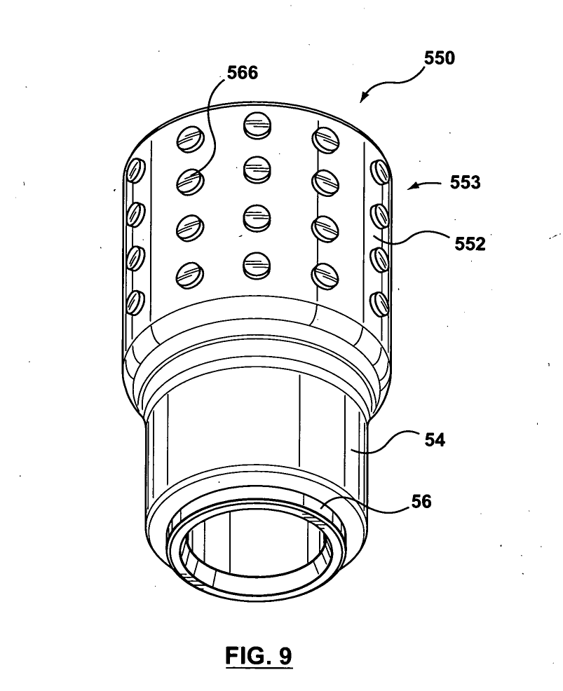

FIG. 9 illustrates the molded part picker 550 in accordance with a fifth embodiment of the present invention. The molded part picker 550 includes a balloon 553 that is configured similarly to the first embodiment except that the plurality of wear members 566 are preferably configured as shaped studs that are arranged to project from the outside of the tubing 552 in an array pattern. The cross-sectional shape of the wear member 552 is preferably circular. Of course, the wear member 552 could otherwise have a cross-sectional shape that is one of circular, rectangular, triangular, or any other polygon.

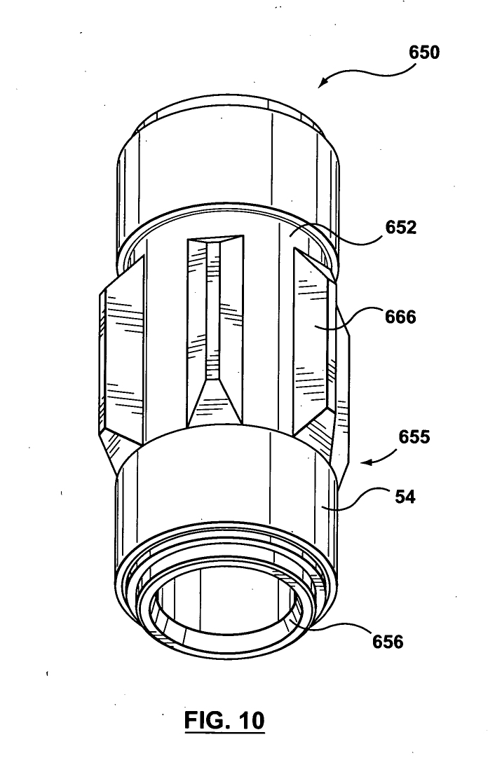

FIG. 10 illustrates the molded part picker 650 in accordance with a sixth embodiment of the present invention. The molded part picker 650 includes a balloon 653 that is configured similarly to the first embodiment except that the tubing 652 is not folded-over on the frame 656.

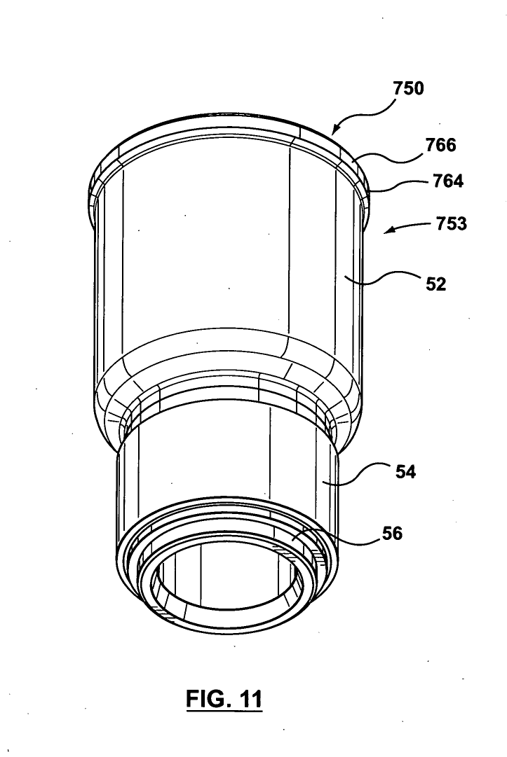

FIG. 11 illustrates the molded part picker 750 in accordance with a seventh embodiment of the present invention. The molded part picker 750 includes a balloon 753 that is configured similarly to the known picker 50 except that an annular wear member 766 is configured to cover at least a portion of the outside corner 764 where the wear is most prominent. In a preferred embodiment the wear member 766 is silicone.

In accordance with an eight embodiment of the present invention (not shown) the balloon includes a random distribution of wear members.

Preferably the balloon 153, 253, 353, 453, 553, 653, and 753 comprises tubing 152, 252, 352, 452, 552, 652, and 752 and wear members 166, 266, 366, 466, 566, 666, and 766 that are integrally extruded, and wherein they are made from the same material. In an accordance with an alternative embodiment of the invention, the tubing 152, 252, 352, 452, 552, 652, and 752 and wear members 166, 266, 366, 466, 566, 666, and 766 are integrally co-extruded, and wherein the tubing 152, 252, 352, 452, 552, 652, and 752 and wear members 166, 266, 366, 466, 566, 666, and 766 are made from materials having at least one distinct physical property. Alternatively, the wear members 166, 266, 366, 466, 566, 666, and 766 may be separately formed and bonded to the balloon 153, 253, 353, 453, 553, 653, and 753. Preferably the bonding is achieved by means of vulcanizing. Of course, the balloon 153, 253, 353, 453, 553, 653, and 753, tubing 152, 252, 352, 452, 552, 652, and 752, and/or wear members 166, 266, 366, 466, 566, 666, and 766 may be formed by other means such as injection molding, either integrally or separately. As another alternative the wear members 166, 266, 366, 466, 566, 666, and 766 may be configured as a coating that is bonded to the balloon 153, 253, 353, 453, 553, 653, and 753. Presently preferred materials for forming the tubing 152, 252, 352, 452, 552, 652, and 752 and wear members 166, 266, 366, 466, 566, 666, and 766, although not an exclusive listing, includes elastomers such as SANTOPRENE (a trade-mark of Monsanto Corporation), Latex, ethylene propylene diene monomer (EPDM), Urethane, PVC-Urethane blends, and any combination or permutation thereof.

In accordance with an alternative embodiment, the wear members 166, 266, 366, 466, 566, 666, and 766 may be molded to have a different physical property than the tubing 152, 252, 352, 452, 552, 652, and 752. For example, the wear member 166, 266, 366, 466, 566, 666, and 766 may have a contrasting colour with the tubing 152, 252, 352, 452, 552, 652, and 752 as a visible indication of wear. As another example, the wear member 166, 266, 366, 466, 566, 666, and 766 the physical property is wear resistance and wherein the wear member material has a higher wear resistance than the tubing material.

A further advantage may be derived from an embodiment of the molded part picker 150, 250, 350, 450, 550, and 650 in a molded part transfer and cooling device, such as the COOLJET device 14, wherein the cooling fluid flow from the cooling pin 26 may continue to flow during the period that the molded part 2 is being gripped by the molded part picker 150, 250, 350, 450, 550, and 650. In particular, any gap that may be defined between an inside surface of the molded part 2 and the space between adjacent the wear members 166, 266, 366, 466, 566, and 666, may be used to support the cooling fluid flow. Clearly, the flow is a function of the size of the gap and the fluid pressure.

In conclusion, a wear resistant molded part picker 150, 250, 350, 450, 550, 650 and 750 has been described that is molded particularly well suited, although not exclusively, for the handling of molded parts such as injection molded preforms, blow molded bottles, and the like, by gripping an inside surface thereof. Accordingly, the molded part picker 150, 250, 350, 450, 550, 650 and 750 may be fitted, or otherwise retrofitted into devices such as a post-mold transfer and cooling device, a molded part transfer device in a blow molding system, or a molded part transfer device in a bottling system.

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without demolded parting from the concepts as described. Therefore, what is to be protected by way of letters patent are limited only by the scope of the following claims:

What is claimed is:

1. A molded part picker (150, 250, 350, 450, 550, 650, 750), comprising:
a balloon (152, 252, 352, 452, 552, 652, 752) being inflatable and deflatable, the balloon having a wear member (166, 266, 366, 466, 566, 666, 766).

2. The molded part picker of claim 1, wherein:
the wear member (166, 266, 366, 466, 566, 666, 766) configured to contact a molded part (2) when the balloon (152, 252, 352, 452, 552, 652, 752) is positioned and inflated to do so, and the wear member (166, 266, 366, 466, 566, 666, 766) disengages from the molded part (2) when the balloon (152, 252, 352, 452, 552, 652, 752) is deflated to do so.

3. The molded part picker of claim 1, wherein the wear member (166, 266, 366, 466, 566, 666, 766) extends from the balloon (152, 252, 352, 452, 552, 652, 752).

4. The molded part picker of claim 1, further comprising:
a frame 56 that is configured to support the balloon 153, 253, 353, 453, 553, 653, 753.

5. The molded part picker (150, 250, 350, 450, 550, 650 750) of claim 4, wherein:
the balloon (153, 253, 353, 453, 553, 653, 752) includes a length of stretchable tubing (152, 252, 352, 452, 552, 652) with the wear member (166, 266, 366, 466, 566, 766) extending from an outside thereof;
the tubing (152, 252, 352, 452, 552, 652) sealed on the frame (56) to define a fluid chamber (58) therebetween;
the frame (56) configured for connecting the fluid chamber (58) to a fluid source (31).

6. The molded part picker (150, 250, 350, 450, 550, 650 750) of claim 5, wherein:
the balloon (153, 253, 353, 453, 553, 753) is arranged on the frame (56) to include a folded-over portion (162, 262, 362, 462, 562, 762).

7. The molded part picker (150, 250, 350, 450, 550, and 650) of claim 1, wherein:
there are a plurality of wear members (166, 266, 366, 466, 566, 666) that are arranged in a pattern on the balloon (153, 253, 353, 453, 553, 653).

8. The molded part picker (150, 250, 650) of claim 7, wherein:
the pattern includes arranging the plurality of wear members (166, 266, 666) to extend longitudinally.

9. The molded part picker (150, 250, 650) of claim 8, wherein:
the pattern includes arranging the longitudinally extending wear members (166, 266, 666) in a equi-angularly-spaced array around the balloon (153, 253, 653).

10. The molded part picker (250) of claim 8, wherein:
the pattern includes segmented wear members (266).

11. The molded part picker (350) of claim 7, wherein:
the pattern includes arranging the plurality of wear members (366) to extend circumferentially around the ballon (353).

12. The molded part picker (350) of claim 11, wherein:
the pattern includes arranging the circumferentially extending wear members (366) in a longitudinally-spaced array along the length of the balloon (353).

13. The molded part picker (450) of claim 7, wherein:
the pattern includes arranging the plurality of wear members (466) to extend helically along the length of the balloon (453).

14. The molded part picker (550) of claim 7, wherein:
the pattern includes arranging the plurality of wear members (566) in an array around the balloon (553).

15. The molded part picker (550) of claim 14, wherein:
the plurality of wear members (566) are configured as studs that are arranged to project from the balloon (553), and wherein the wear members (566) have a cross-sectional shape that is one of circular, rectangular, triangular, or any other polygon.

16. The molded part picker (150, 250, 350, 450, 550, 650 750) of claim 1, wherein:
the wear member (166, 266, 366, 466, 566, 766) includes a material configured to have a different physical property than that of the balloon (153, 253, 353, 453, 553, 653).

17. The molded part picker (150, 250, 350, 450, 550, 650 750) of claim 16, wherein:
the physical property is colour and wherein the wear member material has a contrasting colour with the balloon material, wherein a loss of colour in the wear member indicates time to replace the molded part picker (150, 250, 350, 450, 550, 650 750).

18. The molded part picker (150, 250, 350, 450, 550, 650 750) of claim 16, wherein:
the physical property is wear resistance and wherein the wear member material has a higher wear resistance than that of the balloon material.

19. The molded part picker (150, 250, 350, 450, 550, 650 750) of claim 1, wherein:
the wear member (166, 266, 366, 466, 566, 766) is integrally formed with the balloon (153, 253, 353, 453, 553, 653).

20. The molded part picker (150, 250, 350, 450, 550, 650 750) of claim 1, wherein:
the wear member(166, 266, 366, 466, 566, 766) is bonded to the balloon (153, 253, 353, 453, 553, 653).

21. The molded part picker (150, 250, 350, 450, 550, 650 750) of claim 1, wherein:
the wear member (166, 266, 366, 466, 566, 766) is a coating applied to the balloon (153, 253, 353, 453, 553, 653).

22. A molded part transfer device (14) including:
a molded part picker (150, 250, 350, 450, 550, 650, 750), comprising:
a balloon (152, 252, 352, 452, 552, 652, 752) being inflatable and deflatable, the balloon having a wear member (166, 266, 366, 466, 566, 666, 766).

23. The molded part transfer device (14) of claim 22, wherein
the wear member (166, 266, 366, 466, 566, 666, 766) configured to contact a molded part (2) when the balloon (152, 252, 352, 452, 552, 652, 752) is positioned and inflated to do so, and the wear member (166, 266, 366, 466, 566, 666, 766) disengages from the molded part (2) when the balloon (152, 252, 352, 452, 552, 652, 752) is deflated to do so.

24. The molded part transfer device (14) of claim 22, wherein the wear member (166, 266, 366, 466, 566, 666, 766) extends from the balloon (152, 252, 352, 452, 552, 652, 752).

25. The molded part transfer device (14) of claim 22, further comprising:
a frame 56 that is configured to support the balloon 153, 253, 353, 453, 553, 653, 753.

26. The molded part transfer device (14) of claim 25, wherein:
the balloon (153, 253, 353, 453, 553, 653, 752) includes a length of stretchable tubing (152, 252, 352, 452, 552, 652) with the wear member (166, 266, 366, 466, 566, 766) extending from an outside thereof;
the tubing (152, 252, 352, 452, 552, 652) sealed on the frame (56) to define a fluid chamber (58) therebetween;
the frame (56) configured for connecting the fluid chamber (58) to a fluid source (31).

27. The molded part transfer device (14) of claim 26, wherein:
the balloon (153, 253, 353, 453, 553, 753) is arranged on the frame (56) to include a folded-over portion (162, 262, 362, 462, 562, 762).

28. The molded part transfer device (14) of claim 22, wherein:
there are a plurality of wear members (166, 266, 366, 466, 566, 666) that are arranged in a pattern on the balloon (153, 253, 353, 453, 553, 653).

29. The molded part transfer device (14) of claim 28, wherein:
the pattern includes arranging the plurality of wear members (166, 266, 666) to extend longitudinally.

30. The molded part transfer device (14) of claim 29, wherein:
the pattern includes arranging the longitudinally extending wear members (166, 266, 666) in a equi-angularly-spaced array around the balloon (153, 253, 653).

31. The molded part transfer device (14) of claim 29, wherein:
the pattern includes segmented wear members (266).

32. The molded part transfer device (14) of claim 28, wherein:
the pattern includes arranging the plurality of wear members (366) to extend circumferentially around the ballon (353).

33. The molded part transfer device (14) of claim 32, wherein:
the pattern includes arranging the circumferentially extending wear members (366) in a longitudinally-spaced array along the length of the balloon (353).

34. The molded part transfer device (14) of claim 28, wherein:
the pattern includes arranging the plurality of wear members (466) to extend helically along the length of the balloon (453).

35. The molded part transfer device (14) of claim 28, wherein:
the pattern includes arranging the plurality of wear members (566) in an array around the balloon (553).

36. The molded part transfer device (14) of claim 35, wherein: the plurality of wear members (566) are configured as studs that are arranged to project from the balloon (553), and wherein the wear members (566) have a cross-sectional shape that is one of circular, rectangular, triangular, or any other polygon.

37. The molded part transfer device (14) of claim 22, wherein:
the wear member (166, 266, 366, 466, 566, 766) includes a material configured to have a different physical property than that of the balloon (153, 253, 353, 453, 553, 653).

38. The molded part transfer device (14) of claim 37, wherein:
the physical property is colour and wherein the wear member material has a contrasting colour with the balloon material, wherein a loss of colour in the wear member indicates time to replace the molded part picker (150, 250, 350, 450, 550, 650 750).

39. The molded part transfer device (14) of claim 37, wherein:
the physical property is wear resistance and wherein the wear member material has a higher wear resistance than that of the balloon material.

40. The molded part transfer device (14) of claim 22, wherein:
the wear member (166, 266, 366, 466, 566, 766) is integrally formed with the balloon (153, 253, 353, 453, 553, 653).

41. The molded part transfer device (14) of claim 22, wherein:
the wear member (166, 266, 366, 466, 566, 766) is bonded to the balloon (153, 253, 353, 453, 553, 653).

42. The molded part transfer device (14) of claim 22, wherein:
the wear member (166, 266, 366, 466, 566, 766) is a coating applied to the balloon. (53, 253, 353, 453, 553, 653).

43. An injection molding system (10) including a molded part transfer device (14), the molded part transfer device including: a molded part picker (150, 250, 350, 450, 550, 650, 750), comprising:
a balloon (152, 252, 352, 452, 552, 652, 752) being inflatable and deflatable, the balloon having a wear member (166, 266, 366, 466, 566, 666, 766).

44. The molded part transfer device (14) of claim 43, wherein
the wear member (166, 266, 366, 466, 566, 666, 766) configured to contact a molded part (2) when the balloon (152, 252, 352, 452, 552, 652, 752) is positioned and inflated to do so, and the wear member (166, 266, 366, 466, 566, 666, 766) disengages from the molded part (2) when the balloon (152, 252, 352, 452, 552, 652, 752) is deflated to do so.

45. The injection molding system (10) of claim 43, wherein the wear member (166, 266, 366, 466, 566, 666, 766) extends from the balloon (152, 252, 352, 452, 552, 652, 752).

46. The injection molding system (10) of claim 43, further comprising:
a frame 56 that is configured to support the balloon 153, 253, 353, 453, 553, 653, 753.

47. The injection molding system (10) of claim 46, wherein:
the balloon (153, 253, 353, 453, 553, 653, 752) includes a length of stretchable tubing (152, 252, 352, 452, 552, 652) with the wear member (166, 266, 366, 466, 566, 766) extending from an outside thereof;
the tubing (152, 252, 352, 452, 552, 652) sealed on the frame (56) to define a fluid chamber (58) therebetween;
the frame (56) configured for connecting the fluid chamber (58) to a fluid source (31).

48. The injection molding system (10) of claim 47, wherein:
the balloon (153, 253, 353, 453, 553, 753) is arranged on the frame (56) to include a folded-over portion (162, 262, 362, 462, 562, 762).

49. The injection molding system (10) of claim 43, wherein:
there are a plurality of wear members (166, 266, 366, 466, 566, 666) that are arranged in a pattern on the balloon (153, 253, 353, 453, 553, 653).

50. The injection molding system (10) of claim 49, wherein:
the pattern includes arranging the plurality of wear members (166, 266, 666) to extend longitudinally.

51. The injection molding system (10) of claim 50, wherein:
the pattern includes arranging the longitudinally extending wear members (166, 266, 666) in a equi-angularly-spaced array around the balloon (153, 253, 653).

52. The injection molding system (10) of claim 50, wherein:
the pattern includes segmented wear members (266).

53. The injection molding system (10) of claim 49, wherein:
the pattern includes arranging the plurality of wear members (366) to extend circumferentially around the ballon (353).

54. The injection molding system (10) of claim 53, wherein:
the pattern includes arranging the circumferentially extending wear members (366) in a longitudinally-spaced array along the length of the balloon (353).

55. The injection molding system (10) of claim 49, wherein:
the pattern includes arranging the plurality of wear members (466) to extend helically along the length of the balloon (453).

56. The injection molding system (10) of claim 49, wherein:
the pattern includes arranging the plurality of wear members (566) in an array around the balloon (553).

57. The injection molding system (10) of claim 56, wherein:
the plurality of wear members (566) are configured as studs that are arranged to project from the balloon (553), and wherein the wear members (566) have a cross-sectional shape that is one of circular, rectangular, triangular, or any other polygon.

58. The injection molding system (10) of claim 43, wherein:
the wear member (166, 266, 366, 466, 566, 766) includes a material configured to have a different physical property than that of the balloon (153, 253, 353, 453, 553, 653).

59. The injection molding system (10) of claim 58, wherein:
the physical property is colour and wherein the wear member material has a contrasting colour with the balloon material, wherein a loss of colour in the wear member indicates time to replace the molded part picker (150, 250, 350, 450, 550, 650 750).

60. The injection molding system (10) of claim 58, wherein:
the physical property is wear resistance and wherein the wear member material has a higher wear resistance than that of the balloon material.

61. The injection molding system (10) of claim 43, wherein:
the wear member (166, 266, 366, 466, 566, 766) is integrally formed with the balloon (153, 253, 353, 453, 553, 653).

62. The injection molding system (10) of claim 43, wherein:
the wear member (166, 266, 366, 466, 566, 766) is bonded to the balloon (153, 253, 353, 453, 553, 653).

63. The injection molding system (10) of claim 43, wherein:
the wear member (166, 266, 366, 466, 566, 766) is a coating applied to the balloon (153, 253, 353, 453, 553, 653).
